(19) United States
(12) Patent Application Publication
(10) Pub. No.: US 2014/0342314 A1
(43) Pub. Date: Nov. 20, 2014

(54) Implant Tack and Methods of Use Thereof

(71) Applicant: Erick Chamblee, Canton, OH (US)

(72) Inventor: Erick Chamblee, Canton, OH (US)

(21) Appl. No.: 14/258,706

(22) Filed: Apr. 22, 2014

Related U.S. Application Data
(60) Provisional application No. 61/815,046, filed on Apr. 23, 2013.

(51) Int. Cl. A61C 8/02; A61C 8/00

(52) U.S. Cl. CPC A61C 8/0006; A61C 8/0022; A61C 8/0013
USPC 433/167

(57) ABSTRACT

The invention provides apparatus and processes for non-load bearing endosteal implants and specifically to an implant tack for mitigating effects of bone resorption and atrophy due to lost or extracted teeth in the maxilla and/or mandible.

### CROSS-REFERENCE TO RELATED APPLICATIONS

This application claims the priority and benefit of U.S. Provisional Patent Application Ser. No. 61/815,046, titled “Implant Tack and Methods of Use Thereof,” filed Apr. 23, 2013, the entirety of which is incorporated herein by reference.

### FIELD OF THE INVENTION

The invention relates generally to apparatus and processes for non-load bearing endosteal implants and specifically to an implant tack for mitigating effects of bone resorption and atrophy due to lost or extracted teeth in the maxilla and/or mandible.

### BACKGROUND OF THE INVENTION

Preservation of the maxilla and mandible bones is critical for healthy teeth and bone structure. Bone tissue provides structural support for teeth, aids in mastication, and supports soft tissue aesthetics and the oral health of an individual. It is also important for supporting successful implants and dentures used to replace extracted, diseased, injured, and deformed teeth.

Natural teeth and some artificial implants are partially embedded in the jaw bones (maxilla, mandible) and, as in the case with natural teeth, they are attached to the bone by a root structure which, depending on the location and size of the tooth, varies in size, shape and complexity. Similar to muscle and other tissues of the human body, bone tissue must be used in order to maintain it shape and health. While muscle tissue is maintained by exercise, bone tissue is maintained by placing stress or load on it.

Bone tissue is dynamic. The breakdown and rebuilding of bone is a natural, ongoing process that maintains normal, healthy bone where it is needed and removes bone where it is not needed. When the periodontium (the supporting bone and gum tissue around teeth) is diseased (as in the case with periodontitis), the body recognizes that the bone tissue around the tooth is no longer needed and the bone tissue will begin to breakdown. Likewise, when a tooth is lost, the body recognizes that the bone tissue around the lost tooth is no longer needed, and the bone will rapidly begin to resorb, remodel, and atrophy over time. This occurs for at least the following reason. The alveolar bone (which is the portion of the maxilla and mandible bones that anchors the teeth in the mouth) is no longer physically stimulated when teeth are missing, and the alveolar bone begins to resorb and atrophy, leaving a space or defect in the bone. Bone levels are maintained in the maxilla and/or mandible when the bone supports a physical object such as a tooth root or endosteal implant.

The consequences of untreated tooth and bone loss range from physical appearance defects to health-related impacts. For example, appearance-related side effects of tooth loss and subsequent jaw bone deterioration may include additional tooth problems (e.g., loosening and loss), a collapsed facial profile, reduced lip support, increased wrinkling of the skin around the mouth, and distortion of other facial features. Further, health-related side effects may include additional tooth problems (e.g., loosening and loss), jaw pain (temporomandibular joint—TMJ), headaches, drifting/misalignment of the remaining teeth, over-eruption of the remaining teeth, difficulty in communicating, and inadequate nutrition.

The loss or removal and replacement of a tooth with a dental implant or other dental restorative device will likely require one or more procedures. Sometimes bone grafting is used to preserve and/or rebuild the bone around the area of the lost tooth. Bone levels are maintained in the maxilla and/or mandible when the bone supports a physical object such as an endosteal implant. As in the case with an edentulous jaw for instance, bone resorption is continuous unless endosteal implants are placed. The bone around the implants will stabilize and prevent future shrinkage. Bone preservation is achieved when the resorptive process (also referred to as bone shrinkage) is stopped. The success of dental implants depends largely on rapid healing with safe implant integration (also referred to as osseointegration) into the maxilla and/or mandible bones.

Osseointegration derives from the Greek osteon, bone, and the Latin integrate, to make whole. The term refers to the direct structural and functional connection between living bone and the surface of the artificial endosteal implant. Osseointegration is the formation of a direct interface between an implant and bone, without the intervening soft tissue attachment or periodontal ligament. Following tooth loss, osseointegration of an implant is the only means available that can prevent atrophy of bone in the jaw.

Thus, there is a need for a non-load bearing dental implant tack that: (1) can slow and/or stop bone resorption related to a lost or extracted tooth by osseointegration, (2) can preserve and maintain bone tissue in the jaw bone, (3) can be implanted in bone surrounding recently lost and/or extracted teeth, (4) can be used to stop ongoing bone resorption at the site of a lost or extracted tooth, (5) is cost effective to install, (6) is simple to install by using a minimal amount of tools, (7) can be installed in bone tissue adjacent existing teeth and/or endosteal implants, and (8) promotes osseointegration with resident bone tissue. The invention addresses these needs.

### BRIEF DESCRIPTION OF THE DRAWINGS

Additional aspects, features, and advantages of the invention, as to its structure, installation, operation, and use, will be understood and become more readily apparent when the invention is considered in light of the following description of illustrative embodiments made in conjunction with the accompanying drawings, wherein:

FIGS. 1A, 1B, 1C, 1D, and 1E show an implant tack with threads according to an illustrative embodiment of the invention.

FIGS. 1F, 1G, 1H, and 1I show a sequence of steps of a method for implanting an implant tack with threads into bone according to an illustrative embodiment of the invention.

FIGS. 2A, 2B, 2C, 2D, and 2E show a headless implant tack according to another illustrative embodiment of the invention.

FIG. 2F shows an implant driver device that can be used in connection with the methods of the invention.

FIGS. 2G, 2H, and 2I show a sequence of steps of a method for implanting a headless implant tack according to an illustrative embodiment of the invention.

### DETAILED DESCRIPTION OF EMBODIMENTS OF THE INVENTION

Illustrative and alternative embodiments of the implant tack and processes of use thereof are described in reference to the figures that accompany this application. While illustrative embodiments of the invention are shown in the figures of this application and are described generally as an implant tack, alternative embodiments of the invention as well as its features, components, and functionality are also described in this application. The implant tack is non-load bearing, i.e., it does not support an abutment for a crown or denture attachment. Its purpose is to osseointegrate with bone tissue surrounding the implant location in order to help preserve current bone levels. The implant tack is considered an endosteal implant because it will osseointegrate. There are other types of dental implants, e.g., blade implants, subperiosteal implants, etc., which do not osseointegrate. The implant tacks of the present invention must be capable of osseointegration. Any reference to “implant” in this disclosure of the invention means “endosteal implant” unless otherwise indicated.

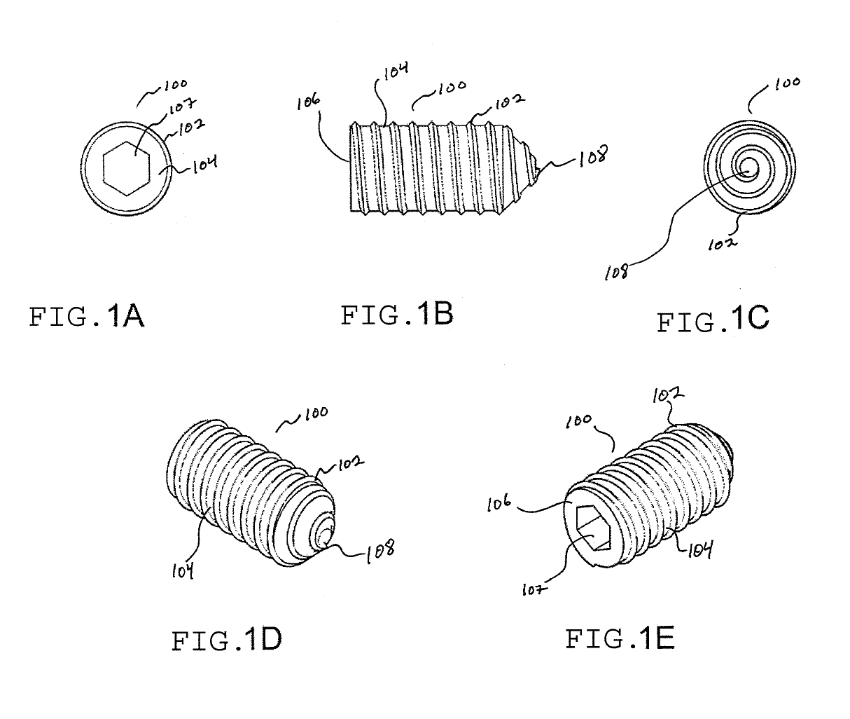

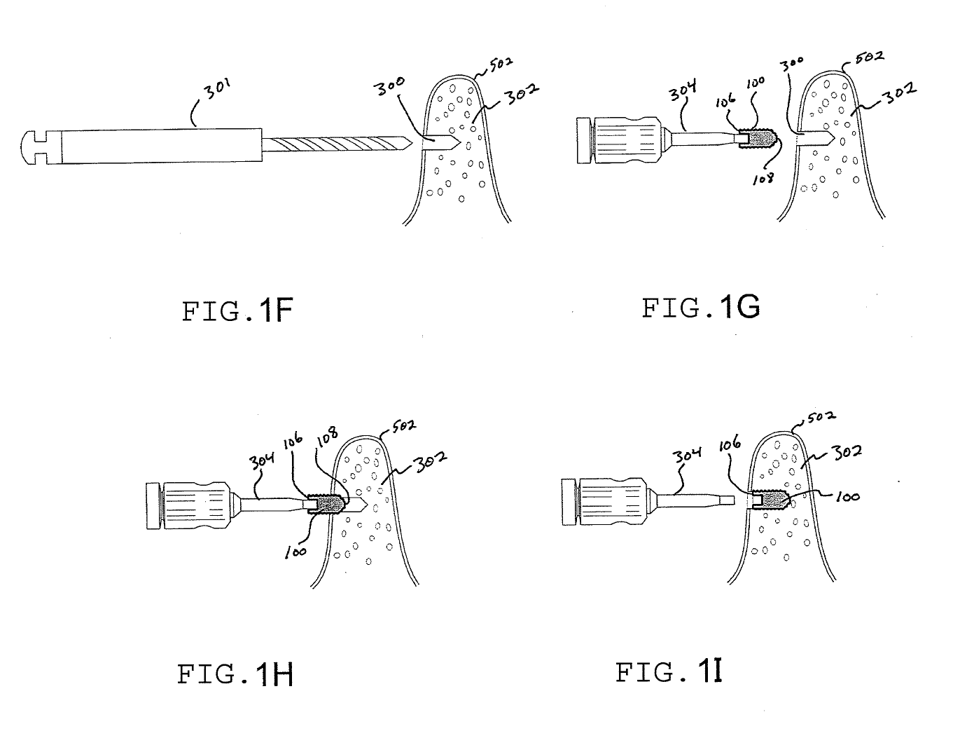

In an illustrative embodiment of the invention shown in FIGS. 1A-1E, implant tack 100 with threads may comprise central elongated body 104 having helical threads 102 that extend away from the longitudinal axis of central elongated body 104. Central elongated body 104 may comprise any longitudinal and cross-sectional symmetrical or asymmetrical shape as described in connection with illustrative embodiments of implant tack 200. Central elongated body 104 may comprise the same or different diameters and lengths as described for illustrative embodiments of implant tack 200.

Implant tack 100 comprises first end 106 and second end 108. First end 106 provides receptacle 107 that interfaces with a driver. Receptacle 107 may be configured to receive a hex head driver (as shown in FIGS. 1A, 1E), a star head driver, a Phillips head driver, or any other driver used in the dental or surgical arts. Second end 108 comprises a tip with a leading end of helical threads 102 shown, for example, in FIG. 1D.

Referring now to FIGS. 1B-1E, helical threads 102 may have a cross-sectional thread form comprising a triangular (scalene, isosceles, equilateral), square, trapezoidal, or other shape. The pitch of the thread form may comprise any suitable pitch for installing implant tack 100. Threads may be course or fine. Helical thread 102 may be self-tapping.

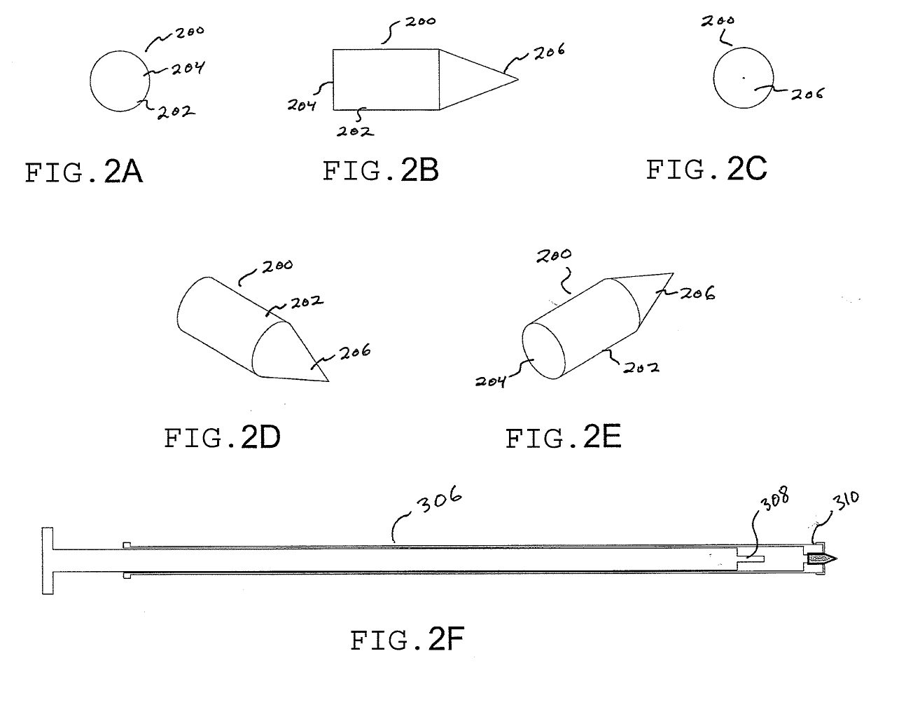

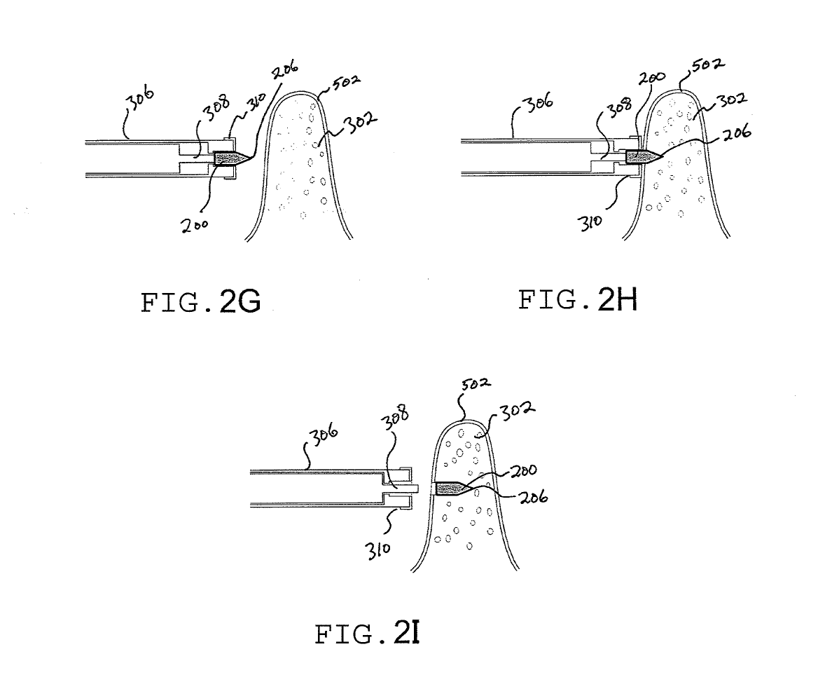

Referring now to an illustrative embodiment of the invention shown in FIGS. 2A-2E, implant tack 200 comprises substantially symmetrical cylindrical or conical body 202 having first end 204 and second end 206. Symmetrical cylindrical or conical body 202 may be straight or bent along its longitudinal axis. In an embodiment, first end 204 comprises a substantially flat surface. This substantially flat surface may be perpendicular to the longitudinal axis of implant tack 200. Second end (or tip) 206 comprises a convergence to a pointed or rounded end. In an embodiment, second end 206 may comprise a convergence of a single surface or a plurality of surfaces that form a prominent point at the second end of implant tack 200. In alternative embodiments, second end 206 may comprise a partially- or substantially-rounded surface. By way of non-limiting examples, the convergence at second end 206 may comprise any one of the following geometric shapes: conical, partially-rounded, rounded, triangular, wedged, tapered, etc.

Of course, implant tack 200 may comprise alternative symmetrical and asymmetrical embodiments. For example, implant tack 200 may comprise a root-form, elliptical, helical, oblong, parabolic, twisted or other shape, any of which may have a substantially straight or bent longitudinal axis. In the alternative embodiments, implant tack 200 may comprise a first end and a second end with the same or similar characteristics as the symmetrical embodiment of implant tack 200 generally shown in FIGS. 2A-2E.

In the aforementioned embodiments (including alternative embodiments), implant tacks 100, 200 may comprise a diameter ranging from about 0.3 mm to about 7 mm or other diameter or length in or near these ranges. Implant tacks 100, 200 may also comprise a length (e.g., from first end to second end) from about 1 mm to about 13 mm or other length in or near these ranges.

There is no direct correlation between, or limitation on, the sizes of the diameter and the length of implant tack 100, 200. In other words, the diameter does not limit the length or vice versa. In an embodiment, implant tack 100, 200 may have a diameter of about 0.75 mm and a length of about 4 mm. In an alternative embodiment, implant tack 100, 200 may have a diameter of about 1.8 mm and a length of about 13 mm.

The cross-sectional view of implant tack of the invention may be round, oval, triangular, square, pentagonal, hexagonal, ellipsoidal, parabolic, or any other symmetrical or asymmetrical geometric shape.

In embodiments, implant tack 100, 200 (threaded or unthreaded variants) may be solid or hollow. Implant tack 100, 200 may comprise any material that is biocompatible and possesses mechanical properties typical for dental implants. For example, implant tack 100, 200 may comprise medical-grade titanium (such as grades 1, 2, 3, or 4) and titanium alloys (such as Ti-6Al-4V), or the like.

Implant tack 100, 200 comprises surface characteristics (e.g., surface modification, surface treatment, or a combination of both) that promotes osseointegration of implant tack 100, 200 in the surrounding bone. Osseointegration takes on its ordinary meaning. The surface characteristics of implant tack that promote osseointegration may include, for example, surface chemistry, topography, wettability, charge, surface energy, crystal structure and crystallinity, roughness, chemical potential, strain hardening, surface presentation of impurities, thickness of titanium oxide layer, and the presence of metal and non-metal composites.

The surface topography of implant tack 100, 200 may comprise macro-roughness (surface features that extend from or recess into the surface of implant tack 100, 200 in a range of millimeters to tens of microns), micro-roughness (surface features that extend from or recess into the surface of implant tack 100, 200 in a range of about 1-10 μm), and nano-roughness (surface features that extend from or recess into the surface of implant tack 100, 200 in a range of from about 1-100 nm).

Surface modifications made to implant tack 100, 200 to enhance osseointegration may result from use of mechanical methods (grinding, blasting, machining, polishing), chemical methods (chemical treatments with acids or alkali, hydrogen peroxide treatment, chemical vapor deposition, or anodization), and physical methods (plasma spraying, sputtering, ion deposition).

Surface treatment of implant tack 100, 200 used to promote osseointegration may comprise turning, blasting, grit-blasting, knurling, acid-etching (single- or dual-etching), sol-gel coating, sandblasting and acid-etching (SLA), porous-sintering, oxidizing, plasma-spraying, hydroxyapatite-coating, fluoride treatment, laser deposition, and sputter deposition (RF or magnetron), as well as combinations of these treatments. Furthermore, surface treatment may include application of biologics, such as biologically-active drugs (bisphosphonates, simvastatin, antibiotic coating), to the surface of the implant tack of the invention.

Implant tacks 100, 200 are designed for osseointegration and are not designed to be removable like a temporary anchorage device (e.g., TAD as used in orthodontics) or a bone tack used to hold a membrane in place such as those used in grafting.

The invention also provides methods for placing one or a plurality of implant tacks 100, 200 in a desired location in bone tissue or in a space within bone tissue in either or both of the maxilla and/or mandible. Placement of implant tack 100, 200 may also occur with one or more endosteal implants or even existing teeth to assist in preserving bone tissue adjacent to the endosteal implant(s), tooth, or teeth. The methods also include maintaining implant tack 100, 200 in contact with surrounding bone tissue for a sufficient time period that promotes osseointegration of implant tack 100, 200 with that bone tissue. Implant tack 100, 200 should be placed in a manner so that it is not affected by a patient's chewing during or after osseointegration.

Placement of implant tack 100, 200 may take place immediately after a tooth is extracted or at a later or other time. Placement may preferably occur before or at the early stages of bone tissue resorbing and remodeling, to avoid bone atrophy.

The implant site may require preparation before placing implant tack 100, 200. Preparation may include making an incision through gum tissue 502 to provide access to the underlying bone unless a communication is already present through gum tissue 502. In either case, osteotomy 300 may be drilled into bone 302 at the location where implant tack 100, 200 may be placed, see, for example, FIG. 1F. This osteotomy 300 may be a pilot hole or pre-tapped hole depending upon the size and characteristics of implant tack 100, 200 and condition of the bone tissue. In an embodiment, implant tack 100, 200 may simply be inserted into the bone 302 without pre-drilling a pilot or other hole, see, for example, FIGS. 2G-2I.

Preparation of the implant location may also include providing general and/or local anesthesia to the patient.

Referring now to FIG. 1G, implant tack 100 shown in FIGS. 1A-1E (or various embodiments of versions of a threaded implant tack) is prepared for placement within bone 302. This form of implant tack 100 may require a more substantial osteotomy 300 as compared to a pilot hole or pre-tapped hole depending upon the size of implant tack 100. Prior to drilling osteotomy 300 with drill 301, gum tissue 502 at the installation site may be incised to provide access to underlying bone tissue 302. Once gum tissue 502 is incised and an appropriately-sized osteotomy 300 is drilled into bone 302 (see FIG. 1F), second end 108 of implant tack 100 is placed adjacent the opening of osteotomy 300 as shown in FIG. 1H. Then, torque is placed on a driver engaged with receptacle 107 in first end 106 of implant tack (e.g., Phillips, slotted, square, star, hex, etc.) using a wrench, driver 304, or similar device. Torque is used to rotate implant tack 100 around its longitudinal axis so that helical threads 102 rotatably engage bone tissue at implant site while implant device 100 is rotated into position in bone 302 (see FIGS. 1H, 1F). In an embodiment, first end 106 of implant tack 100 is flush with the bone surface or, alternatively, below the bone surface as shown in FIG. 1I. First end 106 may extend beyond the surface of bone 302, but this is not preferred. With implant tack 100 in place, gum tissue 502 may be sutured closed if there is an opening in it or, alternatively, left to heal on its own if implant tack 100 was simply driven or forced through uncut gum tissue 502 during placement into bone 302.

Referring now to FIGS. 2F through 2I, implant tack 200 shown in FIGS. 2A through 2E (or various embodiments of versions of an unthreaded implant tack) is placed with its second end (or tip) 206 in contact with the implant location with or without a pilot hole or other hole. Then force is placed on first end 204 of implant tack 200 to drive implant tack 200 into bone 300. This force may be provided by a hammer, a tap, or similar device or, alternatively, by simply placing continuous force on first end 204 of implant tack 200 using plunger device 306 with prong 308 to push implant tack 200 removably secured in end 310 of plunger device 306 into place in bone 300. In any embodiment, implant tack 200 is nailed, driven, or forced into a desired position (e.g., with a mallet and carrier, etc.) within bone 300 so that it is substantially positioned within bone 300. In one embodiment, first end 204 of implant tack 200 is flush with surface of bone 300 or, alternatively, below surface of bone 300. While first end 204 may extend beyond surface of bone 300, this is not preferred. With implant tack 200 in place, gum tissue 502 may be sutured closed if there is an opening in it or, alternatively, left to heal on its own if implant tack 200 was simply driven or forced through uncut gum tissue 502 during placement of implant tack 200 into bone 300.

Multiple implant tacks 100, 200 may be positioned in bone around one or multiple locations.

Implant tack 100, 200 functions to maintain good bone health (by preserving bone) via osseointegration at the placement location and is designed to be contained within bone tissue 302 and under gum tissue 502. Implant tack 100, 200 is not designed to be, nor intended to be used as, an abutment for a denture attachment, crown, or other synthetic tooth material. Thus, implant tack 100, 200 is non-loadbearing.

While the invention is described in conjunction with specific embodiments, it is evident that many alternatives, modifications, permutations, and variations will become apparent to those skilled in the art in light of the foregoing description. Accordingly, it is intended that the invention embraces all such alternatives, modifications, permutations, and variations as falling within the scope of the claims below.

What is claimed is:

1. A non-load bearing, endosteal implant device comprising
a body comprising a surface, a convergence at a first end, and a substantially flat surface at a second end;
a surface topology comprising macro-roughness, micro-roughness and/or nano-roughness; and
a surface treatment to support osseointegration.

2. The non-load bearing, endosteal implant device of claim 1 wherein said body is symmetrical or asymmetrical.

3. The non-load bearing, endosteal implant device of claim 1 wherein said body is straight or bend along a longitudinal axis of said body.

4. The non-load bearing, endosteal implant device of claim 1 wherein said body is cylindrical, root-form, elliptical, helical, oblong, parabolic, or twisted shape.

5. The non-load bearing, endosteal implant device of claim 1 wherein said surface comprises helical threads.

6. The non-load bearing, endosteal implant device of claim 1 wherein said convergence comprises a shape that is conical, partially-rounded, rounded, triangular, wedged, or tapered.

7. The non-load bearing, endosteal implant device of claim 1 wherein said substantially flat surface at said second end comprises a receptacle to receive a driver.

8. The non-load bearing, endosteal implant device of claim 1 wherein said surface treatment comprises one or more of turned, blasted, grit-blasted, knurled, acid-etched (single- or dual-etched), sol-gel coated, sandblasted and acid-etched (SLA), porous-sintered, oxidized, plasma-sprayed, hydroxyapatite-coated surfaces, fluoride treated, laser deposition, and RF or magnetron sputter deposition.

9. The non-load bearing, endosteal implant device of claim 1 wherein said surface treatment comprises one or more biologics or biologically-active drugs.

10. A method of stabilizing bone using a non-load bearing, endosteal implant to mitigate bone resorption and/or atrophy comprising:
providing the non-load bearing, endosteal implant comprising
a body comprising a surface, a convergence at a first end, and a substantially flat surface at a second end, a surface topology comprising macro-roughness, micro-roughness and/or nano-roughness; and a surface treatment to support osseointegration;
positioning the non-load bearing, endosteal implant external to a desired implant location in bone tissue of a maxilla and/or mandible; and
implanting the non-load bearing, endosteal implant within the desired implant location in bone tissue of a maxilla and/or mandible to avoid bone atrophy at the implant location;
wherein the second end of the implant is flush with or below a surface of the bone tissue at the implant location.

11. The method of claim 10 wherein the surface of the implant comprises helical threads.

12. The method of claim 11 wherein the step of implanting the implant comprises providing a pilot hole into the desired implant location in the bone tissue and then placing rotation torque on the implant to screw the implant into the desire implant location.

13. The method of claim 10 wherein the step of implanting the implant comprises placing force on the implant whereby the convergence at the first end of the implant leads the implant into the implant location of the bone tissue.

14. The method of claim 13 wherein the step of placing force on the implant comprises using a hammer, a tap, or plunger device.

15. A method for promoting osseointegration of a non-load bearing, endosteal implant, comprising:
promoting conditions that support osseointegration of the non-lead bearing, endosteal implant into bone tissue, by providing said implant comprising:
a body comprising a surface, a convergence at a first end, and a substantially flat surface at a second end, a surface topology comprising macro-roughness, micro-roughness and/or nano-roughness; and a surface treatment to support osseointegration; and
implanting the non-load bearing, endosteal implant within the desired implant location in bone tissue of a maxilla and/or mandible before or at the early stages of bone tissue resorption and remodeling thereby preventing bone atrophy.

16. The method of claim 15 wherein the surface of the implant comprises helical threads.

17. The method of claim 16 wherein the step of implanting the implant comprises providing a pilot hole into the desired implant location in the bone tissue and then placing rotation torque on the implant to screw the implant into the desire implant location.

18. The method of claim 15 wherein the step of implanting the implant comprises placing force on the implant whereby the convergence at the first end of the implant leads the implant into the implant location of the bone tissue.

19. The method of claim 18 wherein the step of placing force on the implant comprises using a hammer, a tap, or plunger device.

20. The method of claim 15 wherein the second end of the implant is flush with or below a surface of the bone tissue at the implant location.
